(19) United States
(12) Patent Application Publication
(10) Pub. No.: US 2026/0124899 A1
(43) Pub. Date: May 7, 2026

(54) HYBRID ELECTRIC SYSTEM FOR VEHICLE AND DRIVE MECHANISM AND RANGE EXTENDER THEREOF, AND VEHICLE

(71) Applicant: ZF Friedrichshafen AG, Friedrichshafen (DE)

(72) Inventors: Qing Xu, Shanghai (CN); Shaozhi Yuan, Shanghai (CN); Lei Song, Shanghai (CN)

(73) Assignee: ZF Friedrichshafen AG, Friedrichshafen (DE)

(21) Appl. No.: 19/381,929

(22) Filed: Nov. 6, 2025

(30) Foreign Application Priority Data
Nov. 6, 2024 (CN) 202411570927.9
Jul. 15, 2025 (CN) 202510975854.X

(51) Int. Cl. B60K 6/365; B60K 6/405; B60K 6/48; B60K 6/547; F16H 37/08; F16H 57/02; F16H 57/037; F16H 63/04

(52) U.S. Cl. CPC B60K 6/365; B60K 6/405; B60K 6/48; B60K 6/547; F16H 37/0806; F16H 57/037; F16H 63/04; B60K 2006/4825; B60Y 2200/92; F16H 2057/02034; F16H 2057/02052; F16H 2200/0034; F16H 2200/2005; F16H 2200/2094

(57) ABSTRACT

A hybrid electric system for a vehicle and a drive mechanism and a range extender thereof, and a vehicle are disclosed. The mechanism includes: an internal combustion engine drive assembly drivingly connected to an internal combustion engine; a motor drive assembly drivingly connected to a motor; a wheel drive assembly including a planetary gear set, a differential and a synchronizer, the planetary gear set including a sun gear, a planetary carrier and a toothed ring, the sun gear being drivingly connected to the motor drive assembly, the planetary carrier being connected to a housing of the differential, and an output shaft of the differential being connected to wheels; and a clutch configured to drivingly connect or decouple the internal combustion engine drive assembly to or from the motor. The synchronizer can fix the toothed ring against rotation or fixedly connect the toothed ring to the planetary carrier.

### CROSS-REFERENCE TO RELATED APPLICATIONS

This application claims priority to Chinese Patent Application Nos. 202411570927.9, filed on Nov. 6, 2024 and 202510975854.X, filed on Jul. 15, 2025, the entirety of both of which are hereby fully incorporated by reference herein.

### TECHNICAL FIELD

The present disclosure relates to the technical field of automobiles, and in particular to a hybrid electric system for a vehicle and a drive mechanism and a range extender thereof, and a vehicle.

### BACKGROUND

A power train of a pure electric vehicle is generally composed of three parts, namely, a driving motor, a controller, and a traction battery. Due to the limited power supply characteristics of the power train, pure electric vehicles usually face range anxiety when in use. To alleviate range anxiety, the automotive industry has introduced hybrid electric vehicles. A hybrid electric vehicle is a vehicle that is equipped with two power sources, namely a thermal power source (produced by a conventional gasoline or diesel engine) and an electric power source (a traction battery and a driving motor).

For a parallel hybrid electric vehicle, both of an internal combustion engine and a motor can drive one or more driving wheels by a drive unit of the hybrid electric vehicle, so as to improve the vehicle's range. However, the current parallel hybrid electric vehicle has the problem of unsmooth switching of various operating modes, which affects the driving experience of users.

### SUMMARY

Regarding the problems in the prior art, an objective of the present disclosure is to provide a hybrid electric system for a vehicle and a drive mechanism and a range extender thereof, and a vehicle, which meet various drive requirements and improve the driving experience of users.

An embodiment of the present disclosure provides a drive mechanism of a hybrid electric system for a vehicle, including:
an internal combustion engine drive assembly configured to be drivingly connected to an internal combustion engine;
a motor drive assembly configured to be drivingly connected to a motor;
a wheel drive assembly configured to be drivingly connected to wheels; and
a clutch disposed on the internal combustion engine drive assembly or the motor drive assembly and configured to drivingly connect or decouple the internal combustion engine drive assembly to or from the motor drive assembly;
where the wheel drive assembly includes a planetary gear set, a differential and a synchronizer, the planetary gear set including a sun gear, a planetary carrier and a toothed ring, the sun gear being drivingly connected to the motor drive assembly, the planetary carrier being connected to a housing of the differential, and an output shaft of the differential being connected to the wheels;
the planetary carrier outputs a first-gear rotational speed when the synchronizer fixes the toothed ring against rotation and the sun gear rotates;
the wheel drive assembly is decoupled from the wheels when the synchronizer does not fix any rotating element of the planetary gear set; and
the planetary carrier outputs a second-gear rotational speed when the synchronizer fixedly connects the toothed ring to the planetary carrier and the sun gear rotates.

In some embodiments, the drive mechanism further includes a fixed housing, where the synchronizer includes an engagement sleeve, a first engagement ring gear and a second engagement ring gear, and the engagement sleeve is disposed on the toothed ring and movably connected to the toothed ring in an axial direction of the toothed ring; the first engagement ring gear is disposed on the fixed housing; the second engagement ring gear is disposed on the planetary carrier;
the engagement sleeve is engaged with and locked to the first engagement ring gear when the engagement sleeve is at a first axial position;
the engagement sleeve is neither engaged with the first engagement ring gear nor engaged with the second engagement ring gear when the engagement sleeve is at a second axial position; and
the engagement sleeve is engaged with and locked to the second engagement ring gear when the engagement sleeve is at a third axial position.

In some embodiments, the motor drive assembly includes a first input shaft and a first output shaft, and the wheel drive assembly further includes a first gear, a second input shaft and a second gear; and the first gear is fixed to the first output shaft, the sun gear is fixed to a first end of the second input shaft, the second gear is fixed to a second end of the second input shaft, and the first gear and the second gear are meshingly connected.

In some embodiments, the first input shaft and the first output shaft are drivingly connected by a reduction gear set, and a planetary carrier of the reduction gear set is fixedly connected to the first output shaft.

In some embodiments, the motor drive assembly includes a first input shaft, a reduction gear set, a first output shaft and a fixed housing, the first input shaft and the first output shaft being drivingly connected by the reduction gear set, a planetary carrier of the reduction gear set being fixedly connected to the fixed housing, and the first output shaft being fixedly connected to a toothed ring of the reduction gear set; the wheel drive assembly further includes a second input shaft and a second gear; and the sun gear is fixed to a first end of the second input shaft, the second gear is fixed to a second end of the second input shaft, and the toothed ring of the reduction gear set is meshingly connected to the second gear.

In some embodiments, the internal combustion engine drive assembly includes a second output shaft, and the clutch is disposed on the first output shaft or the second output shaft.

In some embodiments, the drive mechanism further includes a driving mechanism that controls the engagement sleeve to move toward the first axial position, the second axial position or the third axial position.

In some embodiments, the internal combustion engine drive assembly includes a torsional damper arranged between the internal combustion engine and the clutch.

In some embodiments, the planetary gear set, the differential and the synchronizer are coaxially arranged about an output shaft of the differential.

An embodiment of the present disclosure further provides a range extender of a hybrid electric system for a vehicle, the range extender including:
a drive mechanism according to any one of the above embodiments, and
a motor drivingly connected to the motor drive assembly of the drive mechanism.

An embodiment of the present disclosure further provides a hybrid electric system for a vehicle, including:
the range extender as described above, and
an internal combustion engine drivingly connected to an internal combustion engine drive assembly of a drive mechanism of the range extender,
where
the internal combustion engine drive assembly is drivingly connected to the motor drive assembly when the clutch is engaged;
the planetary carrier outputs a first-gear rotational speed when the synchronizer fixes the toothed ring against rotation and the sun gear rotates;
the wheel drive assembly is decoupled from the wheels when the synchronizer does not fix any rotating element of the planetary gear set; and
the planetary carrier outputs a second-gear rotational speed when the synchronizer fixedly connects the toothed ring to the planetary carrier and the sun gear rotates.

An embodiment of the present disclosure further provides a vehicle including the hybrid electric system as described above.

The hybrid electric system for a vehicle and the drive mechanism and the range extender thereof, and the vehicle provided by the present disclosure have the following advantages:

According to the present disclosure, the drive connection between the internal combustion engine drive assembly and the motor drive assembly is controlled by the clutch, the motor drive assembly and the wheel drive assembly are drivingly connected by the planetary gear set, and the synchronizer controls the drive connection between the wheel drive assembly and the wheels. Therefore, by controlling different states of engagement between the clutch and the synchronizer, various power transmission requirements can be met, and all drive modes can be switched smoothly, so that the driving experience of users can be improved.

Other features, objectives, and advantages of the present disclosure will become more apparent by reading the detailed description of non-limiting embodiments with reference to the following accompanying drawings.

### BRIEF DESCRIPTION OF THE DRAWINGS

FIG. 1 is a schematic diagram of a hybrid electric system according to an embodiment of the present disclosure;

FIG. 2 is a schematic diagram of an engagement sleeve of a synchronizer at a first axial position according to an embodiment of the present disclosure;

FIG. 3 is a schematic diagram of the engagement sleeve of the synchronizer at a second axial position according to an embodiment of the present disclosure;

FIG. 4 is a schematic diagram of the engagement sleeve of the synchronizer at a third axial position according to an embodiment of the present disclosure; and

FIG. 5 is a schematic diagram of a hybrid electric system according to a further embodiment of the present disclosure.

### DETAILED DESCRIPTION

Now exemplary implementations will be described more fully with reference to the accompanying drawings. However, the exemplary implementations can be implemented in many forms and should not be construed as being limited to the implementations set forth herein. On the contrary, these implementations are provided to make the present disclosure thorough and complete, and to fully convey the concept of the exemplary implementations to those skilled in the art. In the drawings, the same reference signs denote the same or similar structures, and thus the repeated description thereof will be omitted.

In the description of the present application, the description referring to the terms “an embodiment”, “some embodiments”, “an example”, “a specific example”, or “some examples” means that a specific feature, structure, material or characteristic described with reference to the embodiment or example is included in at least one embodiment or example of the present application. Moreover, the specific feature, structure, material, or characteristic described may be combined in any suitable manner in any one or more embodiments or examples. In addition, without mutual contradiction, those skilled in the art may incorporate and combine different embodiments or examples and features of the different embodiments or examples described in the present application.

In addition, the terms “first” and “second” are used for descriptive purposes only, and cannot be construed as indicating or implying relative importance or implicitly indicating the number of technical features indicated. Therefore, the features defined with “first” and “second” may explicitly or implicitly include at least one of the features. In the description of the present application, the meaning of “a plurality of” is two or more, unless explicitly and specifically defined otherwise.

In order to solve the problems in the prior art, an embodiment of the present disclosure provides a drive mechanism of a hybrid electric system for a vehicle. A drive mechanism of a hybrid electric system includes: an internal combustion engine drive assembly configured to be drivingly connected to an internal combustion engine; a motor drive assembly configured to be drivingly connected to a motor; a wheel drive assembly configured to be drivingly connected to wheels; and a clutch disposed on the internal combustion engine drive assembly or the motor drive assembly and configured to drivingly connect or decouple the internal combustion engine drive assembly to or from the motor drive assembly; where the wheel drive assembly includes a planetary gear set, a differential and a synchronizer, the planetary gear set including a sun gear, a planetary carrier and a toothed ring, the sun gear being drivingly connected to the motor drive assembly, the planetary carrier being connected to a housing of the differential, and an output shaft of the differential being connected to the wheels; the planetary carrier outputs a first-gear rotational speed when the synchronizer fixes the toothed ring against rotation and the sun gear rotates; the wheel drive assembly is decoupled from the wheels when the synchronizer does not fix any rotating element of the planetary gear set; and the planetary carrier outputs a second-gear rotational speed when the synchronizer fixedly connects the toothed ring to the planetary carrier and the sun gear rotates.

According to the present disclosure, by controlling different states of engagement between the clutch and the synchronizer, various drive requirements can be met, and all drive modes can be switched smoothly, so that the driving experience of users can be improved.

The drive mechanism of the hybrid electric system for a vehicle, provided by the present disclosure, will be explained in detail below with reference to specific embodiments.

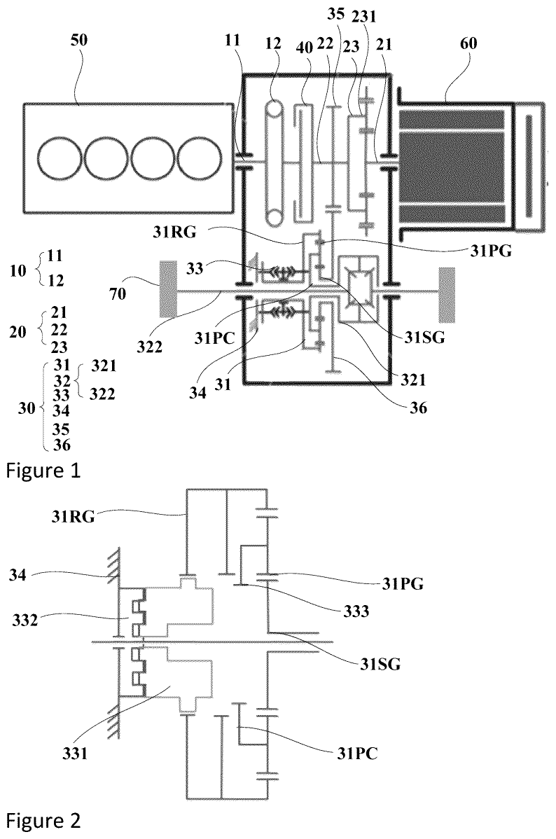

FIG. 1 illustrates a drive mechanism of a hybrid electric system for a vehicle according to an embodiment of the present disclosure, including an internal combustion engine drive assembly 10, a motor drive assembly 20, a wheel drive assembly 30 and a clutch 40.

Specifically, the internal combustion engine drive assembly 10 is configured to be drivingly connected to an internal combustion engine 50; the motor drive assembly 20 is configured to be drivingly connected to a motor 60; the wheel drive assembly 30 is configured to be drivingly connected to wheels 70; and the clutch 40 is disposed on the internal combustion engine drive assembly 10 or the motor drive assembly 20 and configured to drivingly connect or decouple the internal combustion engine drive assembly 10 to or from the motor drive assembly 20.

The wheel drive assembly 30 includes a planetary gear set 31, a differential 32 and a synchronizer 33. The planetary gear set 31 includes a sun gear 31SG, a planetary carrier 31PC and a toothed ring 31RG, where the sun gear 31SG is drivingly connected to the motor drive assembly 20, the planetary carrier 31PC is connected to a housing 321 of the differential 32, and an output shaft 322 of the differential 32 is connected to the wheels 70. As shown in FIG. 1, the planetary gear set 31, the differential 32 and the synchronizer 33 are arranged coaxially about the output shaft 322 of the differential 32.

Further, referring to FIGS. 2 to 4, the drive mechanism further includes a fixed housing 34, the synchronizer 33 includes an engagement sleeve 331, a first engagement ring gear 332 and a second engagement ring gear 333, and the engagement sleeve 331 is disposed on the toothed ring 31RG and movably connected to the toothed ring 31RG in an axial direction of the toothed ring 31RG; the first engagement ring gear 332 is disposed on the fixed housing 34; and the second engagement ring gear 333 is disposed on the planetary carrier 31PC.

As shown in FIG. 2, when the engagement sleeve 331 is at a first axial position, the engagement sleeve 331 is engaged with and locked to the first engagement ring gear 332, i.e., the toothed ring 31RG is fixedly connected to the fixed housing 34. The toothed ring 31RG is fixed against rotation when the fixed housing 34 is at a fixed position on the vehicle. The sun gear 31SG, when rotating, drives the planetary gear 31PG and the planetary carrier 31PC to rotate, and the toothed ring 31RG does not rotate. A rotational speed output by the planetary carrier 31PC is related to a gear ratio of the sun gear 31SG to the planetary gear 31PG. At the moment, the rotational speed output by the planetary carrier 31PC is called as a first-gear rotational speed.

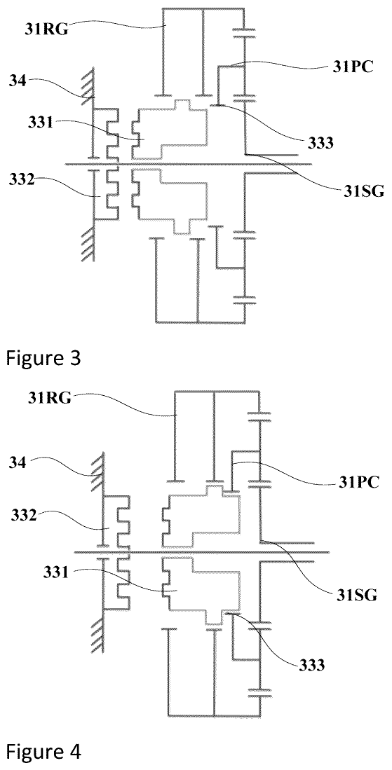

As shown in FIG. 3, the engagement sleeve 331 is neither engaged with the first engagement ring gear 332 nor engaged with the second engagement ring gear 333 when the engagement sleeve 331 is at a second axial position. Since the synchronizer 33 does not fix any rotating element of the planetary gear set 31, i.e., all the rotating elements of the planetary gear set 31 rotate freely, there is no power output from the planetary carrier 31PC at the moment, no effective power can be output to the differential 32, and in turn the wheel drive assembly 30 cannot output power to the wheels 70. Therefore, the wheel drive assembly 30 is decoupled from the wheels 70.

As shown in FIG. 4, when the engagement sleeve 331 is at a third axial position, the engagement sleeve 331 is engaged with and locked to the second engagement ring gear 333, i.e., the toothed ring 31RG is fixedly connected to the planetary carrier 31PC, and the planetary gear set 31 is locked. The sun gear 31SG, when rotating, drives the planetary carrier 31PC and the toothed ring 31RG to rotate simultaneously. The rotational speed output by the planetary carrier 31PC is a rotational speed of the sun gear 31SG, and at the moment, the rotational speed output by the planetary carrier 31PC is called as a second-gear rotational speed. In the embodiment of the present disclosure, the planetary gear set 31 can output two speed levels, which in turn enables more speed options when the vehicle is running, and also optimizes the performance of the internal combustion engine 50 and the motor 60.

When the clutch 40 is controlled to be engaged and the synchronizer 33 does not fix any rotating element of the planetary gear set 31, the internal combustion engine drive assembly 10 is drivingly connected to the motor drive assembly 20, and the wheel drive assembly 30 is decoupled from the wheels 70. Further, the internal combustion engine 50 may be utilized to drive the motor 60 to rotate for power generation to charge a vehicle battery, so as to improve the range of the vehicle; alternatively, the internal combustion engine 50 is started by using the motor 60, thereby improving the starting efficiency of the internal combustion engine 50.

When the clutch 40 is controlled to be engaged, and the synchronizer 33 fixes the toothed ring 31RG against rotation, or the synchronizer 33 locks the planetary gear set 31, the internal combustion engine drive assembly 10 is drivingly connected to the motor drive assembly 20, and the wheel drive assembly 30 is drivingly connected to the wheels 70. Further, the internal combustion engine 50 may be utilized to drive the wheels 70 to rotate.

When the clutch 40 is controlled to be disengaged, and the synchronizer 33 fixes the toothed ring 31RG against rotation, or the synchronizer 33 locks the planetary gear set 31, the internal combustion engine drive assembly 10 is disconnected from the motor drive assembly 20, and the wheel drive assembly 30 is drivingly connected to the wheels 70. Further, the motor 60 may be utilized to drive the wheels 70 to rotate; alternatively, when the vehicle is braked, the motor 60 is used for energy recovery to charge the battery.

Therefore, by controlling the clutch 40 to be engaged and disengaged, and fixing the toothed ring 31RG against rotation by the synchronizer 33 or locking the planetary gear set 31 by the synchronizer 33, various drive connections of the internal combustion engine drive assembly 10, the motor drive assembly 20 and the wheel drive assembly 30 can be realized, which in turn realizes various drive modes and ensures smooth switching between all the drive modes, so that the driving experience of the users can be improved.

Specifically, the motor drive assembly 20 includes a first input shaft 21 and a first output shaft 22, and the wheel drive assembly 30 further includes a second input shaft (not shown), a first gear 35 and a second gear 36; and the first gear 35 is fixed to the first output shaft 22, the sun gear 31SG is fixed to a first end of the second input shaft, the second gear 36 is fixed to a second end of the second input shaft, and the first gear 35 and the second gear 36 are meshingly connected. When the internal combustion engine 50 or the motor 60 drives the first output shaft 22 to rotate, the first gear 35 rotates synchronously, and a rotational torque is transmitted to the second input shaft and the sun gear 31SG by the second gear 36, thereby realizing the drive connection between the motor drive assembly 20 to the wheel drive assembly 30.

As shown in FIG. 1, in some embodiments, the first input shaft 21 and the first output shaft 22 are drivingly connected by a reduction gear set 23, and a planetary carrier of the reduction gear set 23 is fixedly connected to the first output shaft 22. In this embodiment, the reduction gear set 23 may be a planetary reduction gear, and the reduction gear set 23 is configured to reduce a rotational speed of the motor 60 and increase an output torque. The planetary carrier 231 of the reduction gear set 23 is fixedly connected to the first output shaft 22, which is equivalent to that a rotational speed of the planetary carrier 231 of the reduction gear set 23 is the same as a rotational speed of the first output shaft 22. In some other embodiments, the motor drive assembly 20 may include only the first output shaft 22 directly connected to the motor 60, but not the reduction gear set 23.

Further, the internal combustion engine drive assembly 10 includes a second output shaft 11, and the clutch 40 is disposed on the first output shaft 22 or the second output shaft 11. When the clutch 40 is engaged, the first output shaft 22 is connected to the second output shaft 11, i.e., the drive connection between the internal combustion engine drive assembly 10 and the motor drive assembly 20 is realized.

Further, the drive mechanism further includes a driving mechanism (not shown) that controls the engagement sleeve 331 to move toward the first axial position, the second axial position or the third axial position to realize engagement and locking or disengagement between the engagement sleeve 331 and the first engagement ring gear 332, or engagement and locking or disengagement between the engagement sleeve 331 and the second engagement ring gear 333.

Further, the internal combustion engine drive assembly 10 includes a torsional damper 12, and the torsional damper 12 is arranged between the internal combustion engine 50 and the clutch 40. The torsional damper 12 is arranged between the internal combustion engine 50 and the clutch 40 to play a damping role, so as to reduce vibration of the internal combustion engine 50 during power transmission and ensure the smoothness of power transmission. The torsional damper 12 may be regarded as part of the second output shaft 11 of the internal combustion engine drive assembly 10.

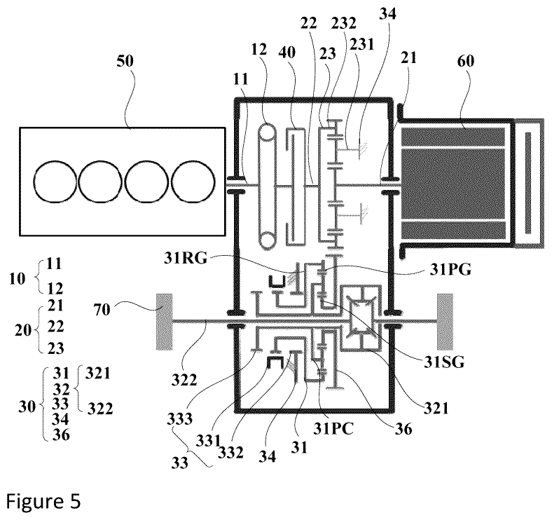

Further, as shown in FIG. 5, another embodiment of the present disclosure further provides a drive mechanism of a hybrid electric system for a vehicle. Compared with the drive mechanism shown in FIG. 1, the drive mechanism in this embodiment differs only in part of the structures of the motor drive assembly 20 and the wheel drive assembly 30, and rest settings are the same. Therefore, specific structural settings of the rest components will not be repeated, and may refer to the above descriptions. Specifically, in FIG. 1, the first input shaft 21 is fixedly connected to the sun gear of the reduction gear set 23, the toothed ring of the reduction gear set 23 is fixed, and the first output shaft 22 is fixedly connected to the planetary carrier of the reduction gear set 23. However, in this embodiment, the motor drive assembly 20 includes a first input shaft 21, a reduction gear set 23 and a first output shaft 22, the first input shaft 21 and the first output shaft 22 being drivingly connected by the reduction gear set 23, the first input shaft 21 being fixedly connected to a sun gear of the reduction gear set 23, a planetary carrier of the reduction gear set 23 being fixedly connected to the fixed housing 34, and the first output shaft 22 being fixedly connected to a toothed ring 232 of the reduction gear set 23; the wheel drive assembly 30 further includes a second input shaft (not shown) and a second gear 36; and the sun gear 31SG is fixed to a first end of the second input shaft, the second gear 36 is fixed to a second end of the second input shaft, and the toothed ring of the reduction gear set 23 is meshingly connected to the second gear 36. In this embodiment, the reduction gear set 23 may be a planetary reduction gear, and the reduction gear set 23 is configured to reduce a rotational speed of the motor 60 and increase an output torque. The toothed ring of the reduction gear set 23 is fixedly connected to the first output shaft 22, which is equivalent to that the toothed ring of the reduction gear set 23 and the first output shaft 22 have the same rotational speed.

An embodiment of the present disclosure further provides a range extender of a hybrid electric system for a vehicle, including the drive mechanism as described above and a motor 60, the motor 60 being drivingly connected to the motor drive assembly 20. The range extender may generate electric energy to charge the battery so as to improve the range of the vehicle.

Further, an embodiment of the present disclosure further provides a hybrid electric system for a vehicle, including the range extender as described above and an internal combustion engine 50, the internal combustion engine 50 being drivingly connected to an internal combustion engine drive assembly 10 of a drive mechanism of the range extender.

The internal combustion engine drive assembly 10 is drivingly connected to the motor drive assembly 20 when the clutch 40 is engaged;

the planetary carrier 31PC outputs a first-gear rotational speed when the synchronizer 33 fixes the toothed ring 31RG against rotation and the sun gear 31SG rotates;
the wheel drive assembly 30 is decoupled from the wheels 70 when the synchronizer 33 does not fix any rotating element of the planetary gear set 31; and
the planetary carrier 31PC outputs a second-gear rotational speed when the synchronizer 33 fixedly connects the toothed ring 31RG to the planetary carrier 31PC and the sun gear 31SG rotates.

According to the above descriptions of each component in the hybrid electric system, operating modes of the hybrid electric system provided by the embodiments of the present disclosure will be described below with reference to FIGS. 1 to 4.

Charging mode: the clutch 40 is engaged, the engagement sleeve 331 of the synchronizer 33 is neither engaged with the first engagement ring gear 332 nor engaged with the second engagement ring gear 333, and when the internal combustion engine 50 drives the motor 60 to rotate, the motor 60 acts as a generator for power generation, so as to charge the battery and improve the storage capacity of the battery.

Motor driving mode: the clutch 40 is disengaged, the engagement sleeve 331 of the synchronizer 33 is engaged with and locked to the first engagement ring gear 332, and the toothed ring 31RG is fixed against rotation; and the motor 60, when running, drives the sun gear 31SG to rotate, and the planetary carrier 31PC outputs a first-gear rotational speed.

The clutch 40 is disengaged, the engagement sleeve 331 of the synchronizer 33 is engaged with and locked to the second engagement ring gear 333, and the planetary gear set 31 is locked; and the motor 60, when running, drives the sun gear 31SG to rotate, and the planetary carrier 31PC outputs a second-gear rotational speed.

Internal combustion engine driving mode: the clutch 40 is engaged, the engagement sleeve 331 of the synchronizer 33 is engaged with and locked to the first engagement ring gear 332, the toothed ring 31RG is fixed against rotation, the internal combustion engine 50, when running, drives the sun gear 31SG to rotate, and the planetary carrier 31PC outputs a first-gear rotational speed.

The clutch 40 is engaged, the engagement sleeve 331 of the synchronizer 33 is engaged with and locked to the second engagement ring gear 333, the planetary gear set 31 is locked, the internal combustion engine 50, when running, drives the sun gear 31SG to rotate, and the planetary carrier 31PC outputs a second-gear rotational speed.

Motor starting internal combustion engine mode: the clutch 40 is engaged, the engagement sleeve 331 is neither engaged with or locked to the first engagement ring gear 332 nor engaged with or locked to the second engagement ring gear 333, and the motor 60, when running, assists in starting the internal combustion engine 50.

Wheel decoupling mode: the engagement sleeve 331 of the synchronizer 33 is neither engaged with or locked to the first engagement ring gear 332 nor engaged with or locked to the second engagement ring gear 333, all the rotating elements of the planetary gear set 31 rotate freely without power output, and the wheel drive assembly 30 is decoupled from the wheels 70.

Energy recovery mode: the clutch 40 is disengaged, the engagement sleeve 331 of the synchronizer 33 is fixed to the first engagement ring gear 332, or the engagement sleeve 331 of the synchronizer 33 is fixed to the second engagement ring gear 333, the motor 60 may generate a reverse induced current to recharge the battery, and a reverse electromotive force may also exert a reverse torque onto the motor 60 and act on the wheels 70, thereby generating an electric braking force that decelerates the vehicle.

It should be noted that the drive system shown in FIG. 5 differs from the drive system shown in FIG. 1 only in part of the structures of the motor drive assembly 20 and the wheel drive assembly 30, and the rest settings are the same. A reference therefore may be made to the above descriptions for the operating principle of the drive system shown in FIG. 5, which will not be repeated herein.

An embodiment of the present disclosure further provides a vehicle including the hybrid electric system as described above. All the technical effects of the hybrid electric system as described above can be achieved by the vehicle according to the embodiments of the present disclosure and will not be described here again.

Further, the range extender or the vehicle including the above drive mechanism is provided with a controller for controlling, in different drive demand modes, the driving mechanism to drive the engagement sleeve 331 to the axial positions, so as to realize output of the first-gear rotational speed, output of the second-gear rotational speed or no power output by the wheels 70.

The hybrid electric system for a vehicle and the drive mechanism and the range extender thereof, and the vehicle provided by the present disclosure have the following advantages:

According to the present disclosure, the internal combustion engine drive assembly is controlled by the clutch to be drivingly connected to or decoupled from the motor drive assembly; the motor drive assembly and the wheel drive assembly are drivingly connected by the planetary gear set; and the wheel drive assembly is controlled by the synchronizer to be drivingly connected to or decoupled from the wheels. Therefore, by controlling the operating states of the clutch and the synchronizer, various drive requirements can be met, the hybrid electric system can achieve the charging operating mode, the internal combustion engine driving mode, the motor driving mode, the motor starting internal combustion engine mode, the energy recovery mode, the wheel decoupling mode, etc., and all the drive modes can be switched smoothly, so that the driving experience of the users can be improved.

The above is a further detailed description of the present disclosure with reference to the specific preferred implementations, and it cannot be considered that the specific implementation of the present disclosure is limited to these descriptions. For those of ordinary skill in the art of the present disclosure, several simple deductions or substitutions can be further made without departing from the concept of the present disclosure, and should be regarded as falling within the scope of protection of the present disclosure.

### LIST OF REFERENCE SIGNS

| | | | |
|---|---|---|---|
| 10 | Internal combustion | 31PC | Planetary carrier |
| | engine drive assembly | | |
| 11 | Second output shaft | 32 | Differential |
| 12 | Torsional damper | 321 | Housing of differential |
| 20 | Motor drive assembly | 322 | Output shaft of differential |
| 21 | First input shaft | 33 | Synchronizer |
| 22 | First output shaft | 331 | Engagement sleeve |
| 23 | Reduction gear set | 332 | First engagement ring |
| | | | gear |
| 231 | Planetary carrier of | 333 | Second engagement ring |
| | reduction gear set | | gear |
| 232 | Toothed ring of | 34 | Fixed housing |
| | reduction gear set | | |
| 30 | Wheel drive assembly | 35 | First gear |
| 31 | Planetary gear set | 36 | Second gear |
| 31SG | Sun gear | 40 | Clutch |
| 31PG | Planetary gear | 50 | Internal combustion |
| | | | engine |
| 31RG | Toothed ring | 60 | Motor |
| | | 70 | Wheel |

1. A drive mechanism of a hybrid electric system for a vehicle, comprising:
an internal combustion engine drive assembly configured to be drivingly connected to an internal combustion engine;
a motor drive assembly configured to be drivingly connected to a motor;
a wheel drive assembly configured to be drivingly connected to wheels; and
a clutch disposed on the internal combustion engine drive assembly or the motor drive assembly and configured to drivingly connect or decouple the internal combustion engine drive assembly to or from the motor drive assembly,
wherein the wheel drive assembly comprises a planetary gear set, a differential and a synchronizer, the planetary gear set comprising a sun gear, a planetary carrier and a toothed ring, the sun gear being drivingly connected to the motor drive assembly, the planetary carrier being connected to a housing of the differential, and an output shaft of the differential being connected to the wheels,
wherein the planetary carrier outputs a first-gear rotational speed when the synchronizer fixes the toothed ring against rotation and the sun gear rotates,
wherein the wheel drive assembly is decoupled from the wheels when the synchronizer does not fix any rotating element of the planetary gear set, and
wherein the planetary carrier outputs a second-gear rotational speed when the synchronizer fixedly connects the toothed ring to the planetary carrier and the sun gear rotates.

2. The drive mechanism according to claim 1, further comprising:
a fixed housing,
wherein the synchronizer comprises an engagement sleeve, a first engagement ring gear and a second engagement ring gear, and the engagement sleeve is disposed on the toothed ring and movably connected to the toothed ring in an axial direction of the toothed ring,
wherein the first engagement ring gear is disposed on the fixed housing,
wherein the second engagement ring gear is disposed on the planetary carrier,
whereni the engagement sleeve is engaged with and locked to the first engagement ring gear when the engagement sleeve is at a first axial position,
wherein the engagement sleeve is neither engaged with the first engagement ring gear nor engaged with the second engagement ring gear when the engagement sleeve is at a second axial position, and
wherein the engagement sleeve is engaged with and locked to the second engagement ring gear when the engagement sleeve is at a third axial position.

3. The drive mechanism according to claim 2,
wherein the motor drive assembly comprises a first input shaft and a first output shaft, and the wheel drive assembly further comprises a first gear, a second input shaft and a second gear, and
wherein the first gear is fixed to the first output shaft, the sun gear is fixed to a first end of the second input shaft, the second gear is fixed to a second end of the second input shaft, and the first gear and the second gear are meshingly connected.

4. The drive mechanism according to claim 3,
wherein the first input shaft and the first output shaft are drivingly connected by a reduction gear set, and a planetary carrier of the reduction gear set is fixedly connected to the first output shaft.

5. The drive mechanism according to claim 3,
wherein the internal combustion engine drive assembly comprises a second output shaft, and the clutch is disposed on the first output shaft or the second output shaft.

6. The drive mechanism according to claim 2,
wherein the motor drive assembly comprises a first input shaft, a reduction gear set and a first output shaft, the first input shaft and the first output shaft being drivingly connected by the reduction gear set, a planetary carrier of the reduction gear set being fixedly connected to the fixed housing, and the first output shaft being fixedly connected to a toothed ring of the reduction gear set,
wherein the wheel drive assembly further comprises a second input shaft and a second gear, and
wherein the sun gear is fixed to a first end of the second input shaft, the second gear is fixed to a second end of the second input shaft, and the toothed ring of the reduction gear set is meshingly connected to the second gear.

7. The drive mechanism according to claim 2, further comprising:
a driving mechanism that controls the engagement sleeve to move toward the first axial position, the second axial position or the third axial position.

8. The drive mechanism according to claim 1,
wherein the internal combustion engine drive assembly comprises a torsional damper arranged between the internal combustion engine and the clutch.

9. The drive mechanism according to claim 1,
wherein the planetary gear set, the differential and the synchronizer are coaxially arranged about an output shaft of the differential.

10. A range extender of a hybrid electric system for a vehicle, comprising:
the drive mechanism according to claim 1; and
a motor drivingly connected to the motor drive assembly of the drive mechanism.

11. A hybrid electric system for a vehicle, comprising:
the range extender according to claim 10; and
an internal combustion engine drivingly connected to an internal combustion engine drive assembly of a drive mechanism of the range extender,
wherein the internal combustion engine drive assembly is drivingly connected to the motor drive assembly when the clutch is engaged,
wherein the planetary carrier outputs a first-gear rotational speed when the synchronizer fixes the toothed ring against rotation and the sun gear rotates,
wherein the wheel drive assembly is decoupled from the wheels when the synchronizer does not fix any rotating element of the planetary gear set, and
wherein the planetary carrier outputs a second-gear rotational speed when the synchronizer fixedly connects the toothed ring to the planetary carrier and the sun gear rotates.

12. A vehicle, comprising:
the hybrid electric system of claim 11.
